(19) United States
(12) Patent Application Publication
(10) Pub. No.: US 2018/0309344 A1
(43) Pub. Date: Oct. 25, 2018

(54) Drive-In Electric Turbine (D-IET)

(71) Applicant: Samuel S. De Asis, New York City, NY (US)

(72) Inventor: Samuel S. De Asis, New York City, NY (US)

(21) Appl. No.: 15/530,973

(22) PCT Filed: Apr. 2, 2015
(86) PCT No.: PCT/US15/24080

§ 371 Date: Apr. 3, 2017

Related U.S. Application Data
(60) Provisional application No. 62/064,588, filed on Oct. 16, 2014.

(51) Int. Cl. H02K 7/18; F03G 7/08; F03G 3/08

(52) U.S. Cl. CPC H02K 7/1853; F03G 3/08; F03G 7/08

(57) ABSTRACT

A Drive-In Electric Turbine (D-IET) is an electric turbine that uses the locomotion of gravity through the weight of roving cars, loaded carts, rollers, trucks or trains collectively known herein as gravity-on-wheels (GOWs) that serves as ‘roving gravity’ that pedal down the D-IETs' levers that crank the flywheels that power-up the generators. D-IET uses as primary components: an ‘omega-like’ pedal lever, (tilted by default at 45-degree from the ground) heavy flywheels, free-wheel mechanism and generators interconnected through sprockets, belts and chains. To produce highest energy return of investment (EROI) a plurality of at least ten D-IETs arrayed across a circle or oval track is preferred with the pedal levers visibly protruding along the track's surface, The weight or gravity of the GOWs pedal down the D-IETs' levers to the ground level producing a rotational energy in the heavy flywheels and eventually the generators as they pass over the pedal levers. Then, one or two seconds right after the pass, the pedal levers are returned freely to their default 45-degree tilted positions again by the lever-restorer devices through the gravity of the counterweights ready to be pedaled down again by the next passing GOW even while the flywheels are still spinning because of the freewheel mechanism that allows forward cranking one way but can be reversed freely without affecting the rotating flywheel. And, inasmuch as the D-IETs are laid down and GOWs running in the same circle or oval train track (in train configuration), the ‘down-up-down-up-down’ movement of the pedal levers are being repeated over again and again producing a non-stop rotation of the flywheels and powering up of the generators. And furthermore, because in one embodiment (where the hybrid vehicle switches from gasoline to electrical) the GOWs and the generators can symbiotically power each other resulting in a potentially continuing operation.

### FIELD OF THE INVENTION

Drive-In Electric Turbine (D-IET)- is an electric turbine that uses the weight/gravity of roving vehicles, carts or trains by converting it into a mechanical rotational energy to pedal down levers that crank the flywheels that power up generators through a system known herein as Deviant Energy Actuation Systematized Inertia Symbiosis. “Symbiosis” in the sense that in one embodiment, the hybrid vehicle or trains that basically powers up the generators can in turn be also powered up by the generators and “deviant” because this turbine is non-traditional.

### BACKGROUND OF THE INVENTION

This invention relates to a gravity-operated or weight-assisted apparatus or device for supplying, conserving and/or recovering energy to power up various devices including GENERATORS. In particular, this invention is the amalgamation of among others: the natural forces of gravity and the lever; the utility properties of the wheel, free-wheel mechanism, sprockets, chains, belts and bearings; and the ‘no-beginning-no ending’ attribute of a circle into a simple but powerful device which will make generators operational. Once the generators are operational, the ‘electrical’ produced can be used in various applications like lighting, powering on homes and appliances and can be converted back to ‘mechanical’ through the use of motors for man's practical uses like power saw and similar devices.

Save for solar, virtually all electric power generating plants that exist today like hydro, wind, geothermal, nuclear, or internal combustion engines basically consist of a system that converts the mechanical energy of moving parts into electrical energy through the use of a generator. A generator consists of two main components: stator (stationary part) and rotor (the moving part). A stator is a single or a set of magnets while the rotor is a metal loop which rotates in it. When the metal loop of a rotor revolves between the magnets, the magnetic field associated with electrons in them changes and an electric current is generated in it. With every rotation, the changing magnetic field creates a current which is then transported through a coil to an external electrical circuit. Electric generators can be one of two types, either AC (Alternating Current) or DC (Direct Current). In AC, the current changes direction or alternates as it flows through a circuit while in DC the currents flows uni-directionally (stays the same) as it goes through a circuit. But whether it's AC or DC, the principle involved on how an electrical current is produced by a generator is basically the same—the continuous spinning of the rotor. In commercial power stations they install huge generators with more number and larger magnets in them while the rotors are driven by various sources like falling water in hydroelectric, steam from burning fossils like coal or from fission in nuclear power or by the spark plugs' igniting a choreographed explosion of compressed mixture of gasoline and oxygen in internal combustion engine's chambers which drive the pistons in an alternating and repetitious ‘down-up-down-up’ motion spinning the crankshaft, the flywheel and ultimately the generator producing huge amount of electricity for distribution.

Thus, electrical current can be produced so long as there is enough mechanical power that cranks the flywheel or turbine that will spin the rotor of the generator at a rate of speed and torque capable of producing certain amount of electricity as in above-mentioned power generating plants.

The world today still depends largely on fossil fuel for power generation. According to the Institute for Energy Research (IER), the U.S. energy consumption in 2011 was 82% from fossil fuels and only 18% from other sources. And, in its November 2011 report, the Paris-based International Energy Agency (IEA) predicts that fossil fuels will account for 78% of the overall increase in worldwide energy demand between 2009 and 2035 assuming an annual global economic growth rate of 3.6 percent. Oil remains the single largest fuel although its share in global demand falls from 33 percent to 27 percent per the IEA's Current Policies case. (Hard Facts: www.instituteforenergyresearh.gov)

But because fossil fuel availability is finite coupled by its disastrous effects to humanity and the environment, man is continuously seeking alternatives. As a result, electricity is now being produced using ‘renewable energy’ from natural sources like solar, hydropower and wind power. A wind-powered generator is just one excellent example of how a force of nature is harnessed to produce electricity and the search is continuing. In fact, in New York City, the Verdant Power Roosevelt Island Tidal Energy (RITE) has submerged six turbines in 2002 to generate electricity using the tidal or hydro power generated by the tidal currents of New York City's East River and is adding 30 more to produce about 1 megawatt of electricity for use by about 1,000 homes. (“East River Underwater Turbines Give Jolt To City Power Grid”, DNAinfo.com New York, Jan. 24, 2012).

However, aside from solar, wind and hydraulic power there is an omnipotent/omnipresent power on the earth's surface but which unfortunately we consider as a “burden” rather than as a utility or misusing it. That force is-GRAVITY. It is ironic that despite the advances of today's science, we still do not know whether gravity is a gift or a curse to humanity much less what to do with it. We consider it as an ‘enemy’ and thus we keep ‘fighting’ or misuse it like allegedly powering up perpetual machines which we know is impossible because it violates the basic law of nature or thermodynamics.

Isaac Newton's pioneering works on gravity led to the discovery that the amount of gravity relatively depends on the size, mass of the planet and the distance of the object to the surface of that planet. Thus, if an object weighs 100 lbs. here on Earth's surface, it is only 38 lbs. in both planets Mercury and Mars; 91 lbs. in Venus; and in our Moon, it's merely 16 lbs. Since moving or lifting 100 lbs. requires more effort than moving a 16 or 38 pounder, we consider that extra amount of gravity as a “burden”. Burden because we spend lot of money and efforts to beat or lessen gravity.

But since it is impossible to totally beat gravity, this invention instead “joins” or uses gravity along with the lever, the wheel and the “no-ending-no-beginning” attribute of a circle by combining them together and converting into a simple but powerful and lasting device that will make a generator operational. Although invisible, gravity is always available and powerful; the lever is the simplest of all machines yet, its power cannot be underestimated such that in articulating how powerful the lever is, Archimedes quoted: “Give me a place to stand on and I will move the Earth”; the wheel is one of the oldest but the most important of all inventions such that in its “List of 101 Gadgets That Changed The World”, The Science Channel in 2012 regarded the wheel as the “Number One Invention”.

Secular or otherwise, our own Planet Earth must be truly designed for Mankind and the fact that Earth has the highest gravity among the known “solid planets” in our Solar System is a blessing and not a curse. A hydroelectric power plant is an example of the use of gravity as a utility here on Earth which is impossible such will work in Mercury or Mars even assuming these planets have abundant water because they have less gravity as articulated above. A hydroelectric power plant is simply the utilization of the water's “cascading or moving gravity”. The enormous amount of water that accumulated in the dam have enormous potential energy or ‘standby gravity’ and since water is liquid, it tends to seek its own level by cascading or rushing towards the outlets (channels or penstocks) below where the turbines (flywheels) are installed. The force of the water's cascading gravity spin the turbine/generators and electricity is produced. Therefore, a hydro-electric power plant is simply a utilization of the angular momentum on the blades of the turbines by the linear momentum or gravity of continuous falling water or simply—the “forward-down locomotion of gravity”.

Since a hydropower plant is essentially, just a ‘forward-down’ locomotion of gravity and gravity is omnipresent here on Earth's surface, we can mimic or replace the hydro or water's cascading gravity with exactly the same locomotion of gravity in “roving gravity” (“rovity” for brevity) and produce the same effect—the continuous spinning of flywheels without building those expensive and destructive gigantic dams in remote areas in order to produce enormous gravity and electricity and then distributed locally anymore. Instead, this invention is the reverse—the electricity will be produced right in the locality by installing/laying the needed number of units of this apparatus sufficient to fill the electricity demand of the locality and the excess distributed through the grid. But unlike water, gravity is intangible and invisible such that in its natural state, we cannot touch, move, nor push gravity. However, since all matters have already their own weight or gravity, we can also create a ‘locomotion of gravity’ similar to hydropower simply by loading the so-much needed amount of gravity in a vehicle/truck, cart or a train which by itself is already loaded with immense gravity. The loaded operating vehicle/truck or train are now converted into roving gravity or “gravity-on-wheels” (“GOWs” for brevity) which similar to cascading gravity in hydropower can now be moved/directed wherever, whenever and on whatever application we intend to use as in this invention. Today's unloaded passenger cars on the roads already weigh about 2-3 tons and trucks much higher and train the heaviest. Adding more loads in them means more power and like water's cascading gravity in hydroelectric power plant, the locomotion of gravity through the GOWs produces an angular momentum on the lever and sets this apparatus/device in motion as they pass over the levers of this device.

### SUMMARY OF THE INVENTION

It is an objective of the present invention to provide an energy source utilizing the utility properties of gravity, the wheel and the lever to power up a generator.
It is a second objective of the present invention to use the roving gravity or weight of cars, carts or trains in order to pedal the lever down cranking/spinning the flywheel and the generator producing electricity.
It is a third objective of the present invention to provide a system that uses the excess energy produced by the energy source to power other various devices.
It is a fourth objective of the present invention to provide an energy source for supplying power to various devices without solely relying on an external energy source for supplying power.
It is a fifth objective of the present invention to provide an energy source that can be initially started as desired and terminated also as desired.

The present invention provides an energy source that is capable of producing exponentially more energy than it requires to operate and the excess energy can be used to power devices and/or distributed through the grid system. A single set of this invention uses the following basic major components (pls. see drawings) to generate electricity: two sets of flywheels or drum-like cylinders of about 1 ton; four solid steel shafts of about 4″ diameter attached or welded to each four flat sides of the two cylinders; an omega-like or inverted “U”-shaped pedal lever; generators; sets of freewheel mechanism or ratchet; sprockets; chains/cables; ball/roller bearings; lever-return device with counter-weights, stoppers and pulleys; car or truck (4 tons or higher and preferably hybrid); loaded carts linked or joined together (similar to baggage carts used in the loading and unloading of baggage to and from an airplanes in airports) or as an alternative, heavy rolling cylinders. On its own, this device and the principle involved is not perpetual machine because although it may provide continuous power (until stopped) it still needs external power in order to properly operate as envisioned.

### BRIEF DESCRIPTION OF THE DRAWING

FIG. 1. A representation of the assembled major components comprising this apparatus/device.

FIG. 2. Is the inverted “U” or omega-shaped lever with the sprockets and ball bearing housings and tilted by default at 45-degree angle from the ground level.

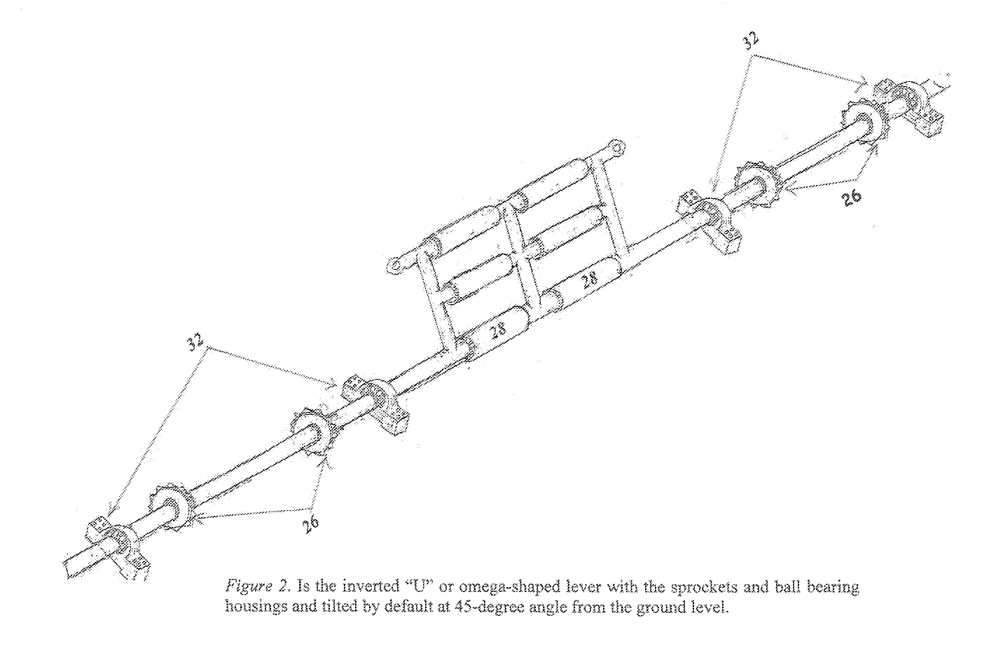

FIG. 3. Is the drum-like flywheel with the shafts, freewheel mechanism and ball bearing housing support.

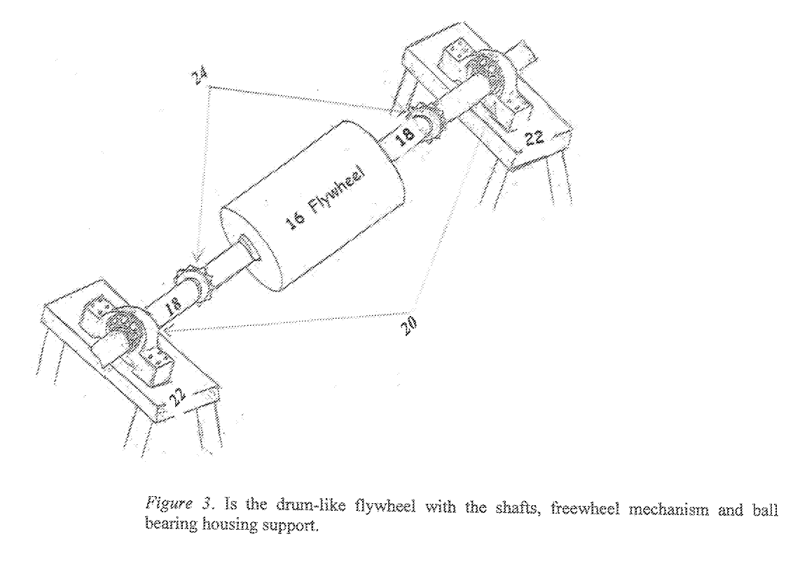

FIG. 4. Is a representation of the two Lever-Return Device (LRD) (at-work) with enlarged illustration. The counterweights return the lever back to its default 45 degree right after it is depressed down by the wheels/GOWs.

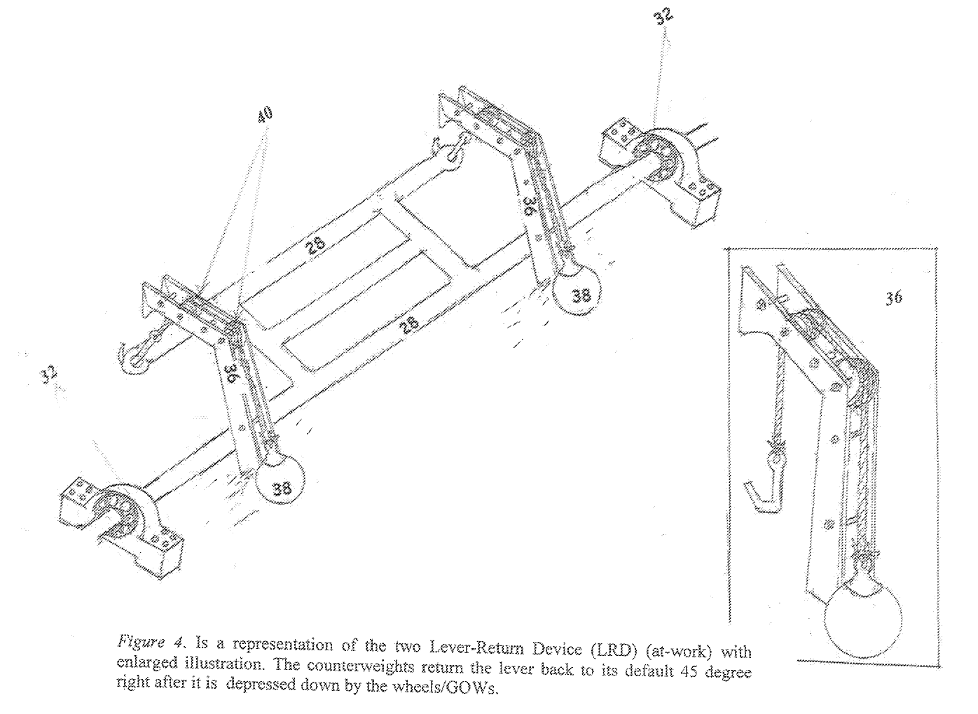

FIG. 5. Is an aerial perspective of a configuration with car/carts serving as lever-depressor (light application configuration.)

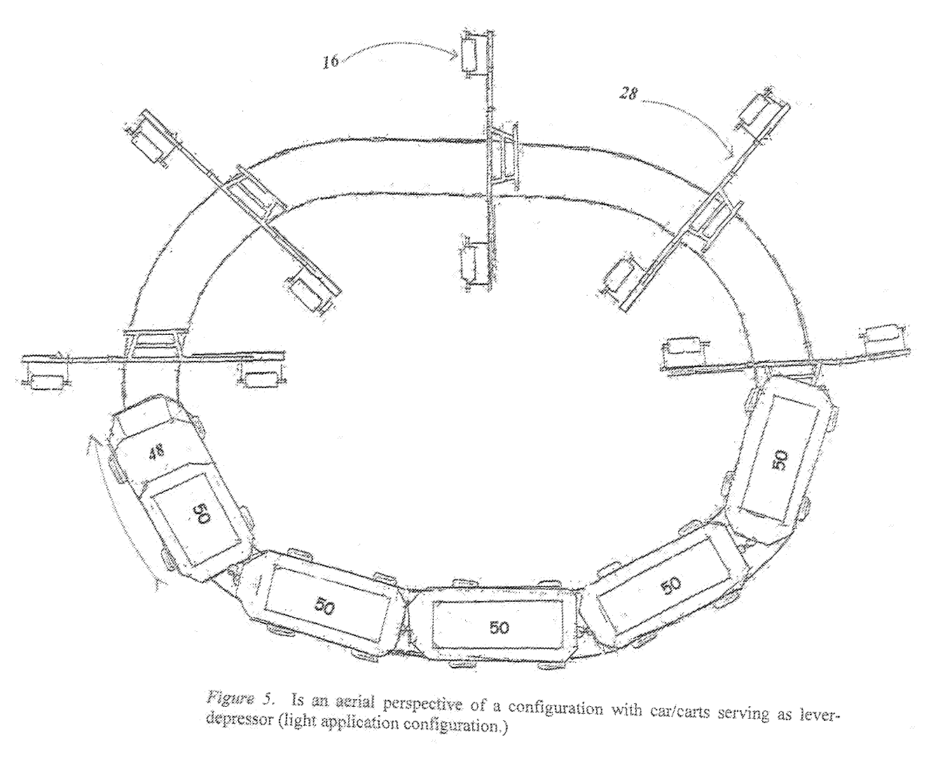

FIG. 6. Is an aerial illustration of a ‘heavy application’ configuration with two sets of trains literally chasing each other as the lever-depressor.

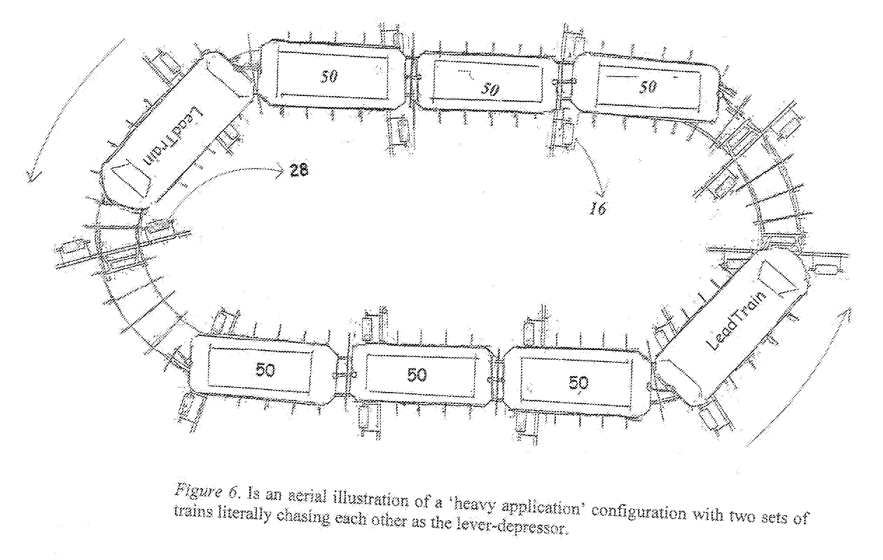

REFERENCE TO NUMERALS IN THE DRAWINGS

10-The Devise
12-Generators
14-Belts
16-Flywheels
18-Shafts
20-Ball Bearings
22-Flywheel Support
24-Free-Wheel Mechanism
26-Sprockets
28-Pedal Lever
30-Chains
32-Mounted Ball Bearings
34-Lever Support
36-Lever-Return Device
38-Counterweight
40-Pulley
42-Stoppers
44-Front Wheels
46-Rear Wheels
48-Truck/Car
50-Carts/Gravity-On-Wheels

### DETAILED DESCRIPTION OF THE INVENTION

A single D-IET with a minimum four generators (but more can be attached) can produce electricity very much higher than a single biggest-propeller wind turbine usually with only one generator but for practical application, economy or higher Energy Return Of Investment (EROI) starting a power turbine with at least ten of this device (with at least 40 generators) is recommended. The ten DIETs are laid along a circular loop pavement (with the 45-degree-tilted-levers visibly protruding across the lane) where the loaded truck and the convoy of four loaded carts or rollers (collectively the GOWs) pass over again and again.

Referring now to the annexed drawings of the present utility embodiment:

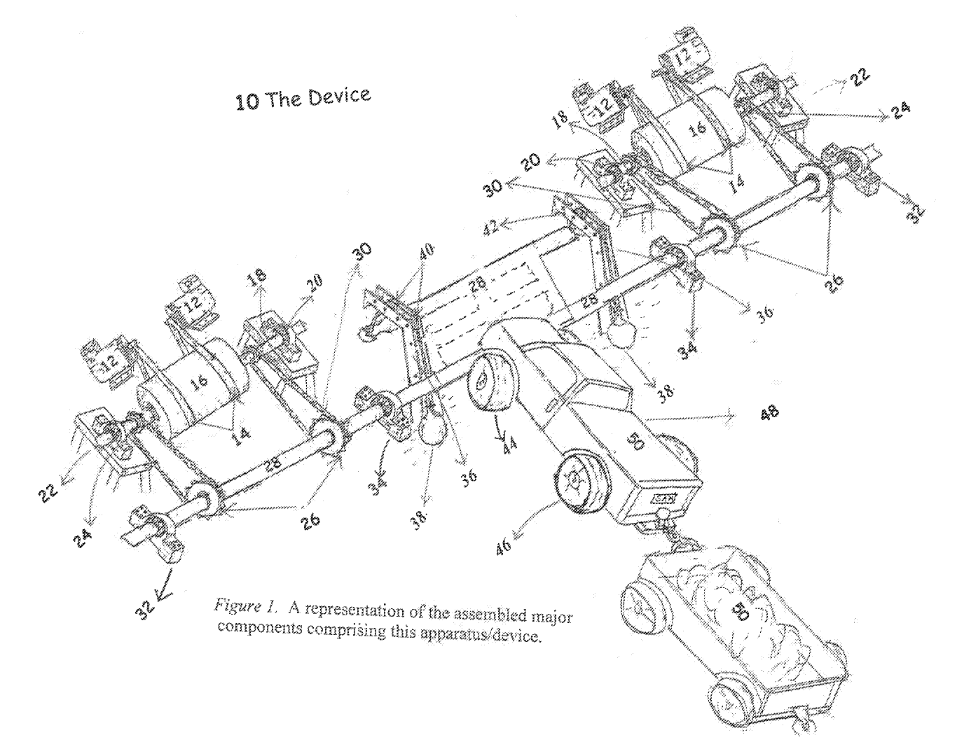

FIG. 1 represents the system of the present invention consisting of: the 10 Device, 12 Generators with 14 Belts connected to the 16 Flywheels. A 16 flywheel is a drum-like cylinder of about a ton suspended and rotating freely on an axle consisting of two solid steel rods or 18 Shafts with one end of each attached/welded to both the flat sides of the 16 flywheel while the other inserted or fitted into a 20 mounted Ball Bearings or roller bearings and secured to a 22 Support Structure for stability when a rotational force is applied. A 24 Free-Wheel mechanism that provides forward-cranking one-way and backwards freely is installed in the 18 shafts and connected to the 26 Sprockets in the omega-shaped 28 Pedal Lever by 30 Chains. The 28 pedal lever is an inverted “U” or omega-shaped solid steel also freely-rotating through the 32 mounted Ball Bearings at both ends and at the middle and 26 sprockets installed directly opposite the 24 freewheel mechanisms in the 18 shaft of the 16 flywheel and linked together by 30 chains and secured to a 34 Support Structure at ground level.

The 28 pedal lever is installed in such manner that when pressed downward by the passing wheels is flushed with the ground level to avoid the passing car or truck from wobbling and by default always tilted up at 45 degrees angle from the ground level by a 36 Lever-Return Device (LRD) through its 38 Counterweights and 40 Pulleys and resting at the 42 Stoppers ready to be depressed down to the ground level when the 44 Front Wheels and 46 Rear Wheels of the 48 Cars/Truck and 50 Loaded Carts/Rollers it's dragging along pass over the lever triggering a rotational force in the 16 flywheels and 12 generators. After the pass is complete, the pedal lever is tilted back up again by the 38 counterweights in the LRD. The power that acts as “pedalist” of the tilted 28 pedal lever that turns the 16 flywheel and ultimately the 12 Generators is the gravity or weight of the 48 car/truck and the 50 loaded carts/rollers concentrated on the 44 front wheels and 46 rear wheels and multiplied exponentially by the fulcrum in the 28 pedal lever.

The ‘powering-up operation’ consist of two cycles and both powered by gravity: The 1^{st} Cycle is the 48 truck entering the loop of protruding 28 tilted levers (Levers 1-10 in a ten-lever configuration) with its 44 front wheels first making contact running over and depressing the 28 Lever#1. The gravity of the 48 truck concentrated on the 44 front wheels depresses the 45-degree-tilted-above-ground pedal 28 Lever#1 all the way to the ground level creating a rotational torque in the 18 shafts spinning the 16 flywheels and the 12 generators through the 13 belts very easily because of the fulcrum in the 28 omega-shaped lever. Then, in a couple of seconds after the 44 front wheels of the truck completely passed-by 28 Lever#1, the 2nd Cycle takes place: the just-depressed pedal 28 Lever#1 is tilted up automatically again to its default 45-degree angle by the 36 lever-return device (LRD) through the gravity of the 38 counterweights and resting on the 42 stopper even while the 16 flywheels are still spinning because of the 24 free wheel mechanism which allows forward cranking one-way but can be reversed freely without affecting the rotating heavy 16 flywheel. Then, as the 48 truck moves on, its 44 front wheels depress the next 28 lever or Lever#2 while the 46 rear wheels depress lever 28 or Lever#1 again.

The cycles or choreography that just took place in Lever#1 & 2 above (of being depressed down by the wheels and lifted again to its default position by the lever return device (LRDs) and depressed again by the next wheels) are replicated in the next levers by the next ‘gravity on wheels’ or GOWs and LRDs' up to the last or Lever#10 and because the GOWs are running in a merry-go-round along the same circle, the ‘down-up-down-up-down’ movement of all ten levers is repeated over and over again creating a continuous pedaling motion and resulting in a continuous rotational force on all the 20 flywheels and 40 generators similar in effect to the motion of the crankshaft that turns the flywheel in internal combustion engine or the ‘cascading gravity’ in hydroelectric. Further, since the flywheels are heavy while the overall resistance or counter drags in the generators, ratchets/sprockets/chains/bearings are relatively light and the interval between the two cycles occurs in few seconds only, the kinetic energy of the spinning heavy flywheel lingers on until the next cycle effecting a non-stop or continuous rotation of the flywheel until stopped and furthermore, because the spinning flywheel's diameter is many times bigger than the generator's rotor, the rotation-per-minute (rpm) of the generator is multiplied exponentially through the chains/belts connecting them together. If the generator rotor's diameter is 4 inches and flywheel is 60 inches, the ratio is 0.066-to-1. This means that for every turn of the flywheel, the generator's rotor rotates 66 times. If the flywheel rotates at 100 rpm the rotor has 6,600 rpm. General purpose generators are rated by the wattage with 800-1200 output at 600-800 rpm.

To ensure a consistent or uniform rotation of the flywheels without needing a ‘brake mechanism’ (to arrest an unpredictable wind gust as in wind turbines) the distances between the wheels of GOWs and in between the D-IET's' pedal levers and the speed of the GOWs be adjusted accordingly: the shorter the distances and higher speed the higher the rpm and inversely. And finally, by the hybrid truck's changing from “gasoline or diesel power” to “electric power” using the power generated and harnessed from the system itself, these GOWs will continue roving around the circle track triggering the continuing down-up-down-up cycle of the pedal levers and spinning the flywheels and generators until the truck is stopped. For an even more powerful application, the car/truck and the GOWs its tagging along can be replaced entirely with a two train-like locomotives literally chasing each other along a big oblong or circular train track with built-in wheels or zigzag-like curvatures of roller bearings underneath that serve as lever depressors of the hundreds or more of these apparatus/devices arrayed along the track depending how much electricity is needed.

FIG. 1. Illustrates basically how simple the apparatus/system looks and works with nothing hidden. D-IETs can be installed easily and safely even inside buildings, ships, cruise ships, tankers, aircraft carriers, in railroads or in public highways by the state or country establishing a sort of a ‘Nationwide-Automobile-Bumps-Utility-Levers-Onsite’ (NABULO) zones where the vehicles will pass through in order to depress the levers of this device in designated portion of the highways (like in areas approaching toll booths or entrances/exits) or in busy intersections dually serving also as “stop signs” in urban metropolis. Once established, these ‘Car-Automated-Turbines-Utilizing-Bump-Induced-Gradients’ (CATUBIG) along the roads will continue producing electricity so long as there are cars/trucks passing by anytime of the day in contrast to intermittent and unpredictable wind, solar or river currents.

In fact, even if the truck or train not switching to automatic/electrical mode and simply using the gasoline or diesel engine alone, this device is still very economical and highest EROI ever because it can produce several times more power than it consumes due to the many generators connected to the circle of D-IETs.

To illustrate: Let's assume that we need to build a power station consisting of the ten D-IETs above (with forty generators minimum) and the circumference of arrayed ten D-IETs is 100 feet and a mile is 5280 feet. This means that the truck and the convoy of four carts or rollers its tagging along (collectively, the GOWs) will make about 52.8 passes around the circle in one mile. If the truck's mileage per gallon (mpg) is at least 10 mpg, it will make 528 turn-arounds on the circle of ten D-IETs per gallon. Assuming the truck consumes two gallons per hour, (the average is 1.2 so far) the 24 hour operation consumes only about 48 gallons of gasoline or only $240.00 per day (at $5.00/gallon) but powering up at least 40 generators. If a single wind turbine of reasonable propeller size at a windy site (with a single generator) produces 1.5 megawatt and can power about 400 homes or 4 large industrial plants. (according to estimates) and we apply the same wattage output here, the 40 generators in this configuration can easily produce 60 megawatts enough to power 16000 homes or 160 industrial plants.

If we use the train configuration and a single train car is 50 feet in length and we adopt a two 5-car trains (ten-cars literally chasing each other along the oblong track) will give us 500 ft. of GOWs. Using the above formulation, (D-IETs laid 10 feet apart with 4 generators) we will have 50 D-IETs with 200 generators producing at least 300 megawatts enough to power 80,000 homes. Installing fifty of this configuration will give 15,000 megawatts or more than the 13,500 megawatts needed to power up the whole of New York City. And, if we install DI-IETs along even only about a quarter of the 656 miles of New York City's active subway tracks, it will power up not only New York City but also the whole Eastern Seaboard.

Theoretically, the mechanics of how this apparatus works is akin to operating the old manual sewing machine: To start, the anterior (toes portion) of the feet pedals the treadle forward-down and upon touching base, (ground) the posterior (heel portion) reverses or tilts it backward-down until it also touches ground; then anterior pedal it forward-down again; posterior reverses again so forth and so on until desired. Although the pedal crank is just a 45-degree turn, (45 to 90) the flywheel that is connected to the treadle continues spinning because the process (pedaling) is being repeated over again and again. This is also similar to a person pedaling a stationary or exercise bike ‘down-up-down’ repeatedly with 45 degree as start-pedal position and ends at 90 degree or the base/ground. After hitting the base, he reverses the pedal back to 45 degree then pedals down to ground again then repeats process again and again. The bike's freewheel mechanism allows reverse-pedaling without affecting the forward-spinning motion of the wheel or flywheel in this invention. But in this invention, the “pedalists” are not human legs but the 3-ton plus gravity of the GOWs directly passing over the pedal levers providing a rotational spin on the flywheels virtually similar in effect to the water's cascading or angular locomotion of gravity in hydro-electric power plant. In other words, this invention is simply a “wheel re-invented”. Sadly, because of the negative connotation of this phrase, man shun away from anything that has something to do with ‘wheel re-invention’ such that we first put human beings on the moon in 1969 (which did not confer any direct benefit to ordinary man's everyday life) but we first put wheels on our luggages only in 1974. This is the reason why this simplest invention hiding in plain sight was overlooked. Indeed, it is very ironic that man-in searching for ‘alternative-to-oil-energy’ sources been looking up high into the sky, digging down deep below but didn't see this one right on his feet until now.

There is nothing wrong with re-inventing the wheel—the greatest invention of man of all times and there is novelty combining existing utilities to create new and revolutionary ones that make man's life more easy and comfortable. After all, the patented camcorder is just a camera and a recorder combined, the smart phone (which History Channel recently considered as the Number One Invention That Changed The World) is simply a consolidation/amalgamation of the existing inventions e.g. the wireless phone, camera, video, GPS, the Walkman, voice recorder, the computer & internet, TV, calculator, clocks, compass, etc. into a single gadget and we consider it “new” because it revolutionized and changed the life of man for the better. Similarly, combining existing age-old inventions like the generator, cars, trains, chains and sprockets, freewheel mechanism, ball bearings, etc. and using the utility properties of gravity and the lever into a device that produces enormous electricity at minimal cost as in this invention, is in many respect-analogous.

### PRIOR ARTS

This invention is the utilization of the power of roving gravity of running cars, trucks, or trains that until now is just being wasted out there. Presently, there are many inventions/contraptions out there that purportedly utilize the weight of vehicles on the road to allegedly produce electricity by building complex contraptions below the surface of the road ever since Earl Wiggins' patented his invention in 1933 under U.S. Pat. No. 1,916,873 A1. To date, this patent resulted many forward-citations among others: U.S. Pat. No. 8,786,115 B2; U.S. Pat. No. 8,344,529 B2; U.S. Pat. No. 8,736,088 B2; U.S. Pat. No. 8,002,495 B2; U.S. Pat. No. 8,334,603 B2; U.S. Pat. No. 8,344,527 B2; U.S. Pat. No. 8,461,700 B2; U.S. Pat. No. 8,461,701 B2; U.S. Pat. No. 8,466,570 B2; U.S. Pat. No. 8,466,571 B2; U.S. Pat. No. 8,471,395 B2; U.S. Pat. No. 8,803,341 B2; U.S. Pat. No. 8,661,806 B2; U.S. Pat. No. 7,714,456 B1; U.S. Pat. No. 8,251,183 B2; U.S. Pat. No. 7,611,305 B2; U.S. Pat. No. 8,070,379 B2; U.S. Pat. No. 7,905,678 B2; U.S. Pat. No. 7,371,030 B2; U.S. Pat. No. 7,589,427 B2; U.S. Pat. No. 7,429,145 B2; U.S. Pat. No. 7,629,698, B2; U.S. Pat. No. 7,419,326 B2; U.S. Pat. No. 7,067,932 B2: U.S. Pat. No. 6,969,213 B2; U.S. Pat. No. 6,858,952 B2; U.S. Pat. No. 6,767,161 B1; U.S. Pat. No. 6,494,144 B1; U.S. Pat. No. 6,362,534 B1; U.S. Pat. No. 4,915,196 A1; U.S. Pat. No. 4,434,374 A1; U.S. Pat. No. 4,250,395 A1; U.S. Pat. No. 4,239,974 A1; U.S. Pat. No. 4,238,687 A1 but none is close to the present invention.

Likewise patents: U.S. Pat. No. 3,943,370; U.S. Pat. No. 4,239,975; U.S. Pat. No. 4,614,875; U.S. Pat. No. 4,657,289; U.S. Pat. No. 4,739,179: U.S. Pat. No. 6,764,275; U.S. Pat. No. 7,530,760; U.S. Pat. No. 7,541,684; U.S. Pat. No. 7,714,456; U.S. Pat. No. 8,070,379; U.S. Pat. No. 8,123,431; U.S. Pat. No. 8,288,879; U.S. Pat. No. 8,680,697; U.S. Pat. No. 8,710,684; US2010-0327602; US2011-0084499; US2011-0101701; US2012-0181796; US2013-0009407; US2013-0068047; US2013-0127176; WO2003-056175A1; WO2004-4067850A1; WO2010-088306A1; U.S. Pat. No. 2,020,361; U.S. Pat. No. 4,144,601: U.S. Pat. No. 4,173,431; U.S. Pat. No. 4,239,975; U.S. Pat. No. 4,739,179; U.S. Pat. No. 4,980,572; U.S. Pat. No. 5,157,922; U.S. Pat. No. 5,355,674; U.S. Pat. No. 5,570,286; U.S. Pat. No. 5,634,774; U.S. Pat. No. 6,091,159; U.S. Pat. No. 6,204,568; U.S. Pat. No. 6,206,049; U.S. Pat. No. 6,353,270: U.S. Pat. No. 6,376,925; U.S. Pat. No. 6,734,575; U.S. Pat. No. 6,756,694; U.S. Pat. No. 6,936,932; U.S. Pat. No. 6,949,840; U.S. Pat. No. 7,145,257; U.S. Pat. No. 7,179,205; U.S. Pat. No. 7,239,031; US2004-0160058; US2007-0111864; US2007-0126239; US2009-0197743; US2009-0315334; US1010-0144496; US20110215589; US2013-0213744 did not come close to the present disclosure. The ‘closest’ so far is U.S. Pat. No. 8,251,183 B2 (in hold italics above) by Ming Cheng Chen but like of all the above it also failed to utilize the simple combinations of the powerful lever, the freewheel and lever-return mechanism, the heavy flywheel and the utility attribute of no-ending-no-beginning attribute of the ‘circle’ as in this present disclosure which interestingly is the simplest. Instead, their designs and the processes are convoluted, very expensive to construct and maintain because they are built underground aside from workability issues and no wonder none have materialized until now. In this invention everything is on the surface but the flywheels and generators can be hidden below if desired.

There are still many other ‘inventions’ that allegedly use gravity but they don't work because they attempt to convert them into perpetual machines which we know is impossible because of thermodynamics laws issues. Although this invention also depends on gravity in order to operate, it is nevertheless used as a separate component akin to gas in internal combustion engines and not in violation of the above law. This invention is the most efficient, cleanest, safest, noiseless, pollution-free and easiest to install and maintain electric power-generating device and the highest Energy Return Of Investment (EROI) rating because similar to jacks, pulleys or levers (over-unity machines) this can produce multiple times more energy than it takes to operate the system and can even be configured to be a self-powering after it is started by an independent or separate “starter”.

Variations and modifications are possible without departing materially from the invention. For instance, the belts can be substituted or replaced with gear boxes, the lever-return device with return springs, or counterweights opposite the inverted “U” of the lever and buried partially or any like mechanisms as long as the lever returns to its default ‘tilted position’ after being depressed down, the freewheel mechanism with ratchets, the wheels underneath the trains that serve as depressors with zigzag-like curvatures of rollers bearings, and other similar devices. Likewise, the materials, sizes and dimensions as set forth herein can be varied to suit to a particular design.

1. Drive-In Electric Turbine (D-IET) is a device or system of producing electricity by the utilization of the natural forces of gravity or weight of an operating loaded vehicle/car/truck/train/carts (collectively as “gravity-on-wheels” or GOWs) as lever-depressors, the utility properties of the lever and the wheels, flywheel, freewheel mechanism, lever-return device, bearings, chains and sprockets, gears, ratchets, the ‘no-ending-no-beginning’ attribute of a circle to produce a continuing mechanical power in order that devices like generators as in this disclosure becomes operational by the GOWs passing over the 45-degree-tilted-above-ground levers of these apparatuses arrayed in plurality along a circle or loop or train track. The weight of the passing vehicles and carts its tagging along or trains (in train configuration) pedal down the levers of this device triggering a rotational force on the flywheels and eventually the generators and returned again freely to its default 45-degree tilted-above-ground position by the lever-return device even while the flywheels are still spinning because of the free-wheel mechanism that provide forward-cranking one way but can be reversed freely to be pedaled down again by the next approaching GOWs thereby producing a non-stop rotation of flywheels and the generators continuously through this device comprising:
(1) two drum-like heavy cylinders serving as flywheels each one hanging on a support structures and through the axles of two solid steel shafts with one end attached/welded to the center of the flat sides of the cylinder and the other inserted to a ball bearing housing support structure and free-wheel mechanism attached at the center of each of the four shafts;
(2) an inverted “U” or extended omega-shaped pedal lever secured to a support structure at ground level by means of ball bearing housings to afford easy rotation with four sprockets attached and positioned directly opposite the four freewheel mechanisms in the flywheels' shafts and tilted at 45 degree default angle above ground ready to be depressed downward by the GOWs;
(3) two lever-return devices with counterweights that pull the pedal levers back to its default 45-degree position after it is depressed down by the GOWs and chains that connect the sprockets in the pedal lever to the freewheel mechanisms and belts to connect the flywheel and generators;
(4) an operating (preferably hybrid) truck tagging or dragging along loaded carts or trains the gravity of which depress down the lever triggering a rotational force on the flywheels and generators and tilted 45-degree back up again by the gravity of the counterweight in the lever-return device and inasmuch as the GOWs are running in the same circular or oval track the down-up-down-up-down motion of the levers, flywheels and generators is repeated over again and again until stopped;
(5) Using the electricity produced by the system itself, (claims 1-4) this device can be self-powering by shifting the hybrid car/truck or train from gasoline/diesel to electrical mode.
